(19) United States
(12) Patent Application Publication
(10) Pub. No.: US 2022/0092464 A1
(43) Pub. Date: Mar. 24, 2022

(54) ACCELERATED MACHINE LEARNING

(71) Applicant: INTERNATIONAL BUSINESS MACHINES CORPORATION, Armonk, NY (US)

(72) Inventors: Martin WISTUBA, Dublin (IE); Tejaswini PEDAPATI, White Plains, NY (US)

(73) Assignee: INTERNATIONAL BUSINESS MACHINES CORPORATION, Armonk, NY (US)

(21) Appl. No.: 16/948,564

(22) Filed: Sep. 23, 2020

(51) Int. Cl. G06N 20/00; G06F 21/55

(52) U.S. Cl. CPC G06N 20/00; G06F 2221/034; G06F 21/554

(57) ABSTRACT

Various embodiments are provided for accelerating machine learning in a computing environment by one or more processors in a computing system. Selected data may be received for training machine learning pipelines. Each of the machine learning pipelines may be scored according to one or more learning curves while training on selected data. Completion of the training on the selected data may be permitted for those of the machine learning pipelines having a score greater than a selected threshold. The training on the selected data may be terminated, prior to completion, on those of the machine learning pipelines having a score less than a selected threshold.

### BACKGROUND

The present invention relates in general to computing systems, and more particularly to, various embodiments for accelerating machine learning in a computing system using a computing processor.

### SUMMARY

According to an embodiment of the present invention, a method for accelerating machine learning in a computing system is provided. Selected data may be received for training machine learning pipelines. Each of the machine learning pipelines may be scored according to one or more learning curves while training on selected data. Completion of the training on the selected data may be permitted for those of the machine learning pipelines having a score greater than a selected threshold. The training on the selected data may be terminated, prior to completion, on those of the machine learning pipelines having a score less than a selected threshold.

In an additional embodiment, a machine learning pipeline trained on a dataset may be selected according to a ranking of the plurality of machine learning pipelines each permitted to complete training on the dataset in response to applying, during the training, one or more learning curves that predicts a machine learning pipeline performance level.

In another embodiment, a one or more machine learning pipelines may be trained using selected data. A learning curve score may be assigned, using one or more learning curves, to the one or more machine learning pipelines during the training. The training of those of the one or more machine learning pipelines having the learning curve score greater than a selected threshold may be allowed while terminating the training of those of the one or more machine learning pipelines having the learning curve score less than a selected threshold. A trained machine learning pipeline may be identified from those of the one or more machine learning pipelines having completed the training based on a ranking of each of the score.

In addition to the foregoing exemplary method embodiments, other exemplary system and computer product embodiments for accelerating machine learning are provided.

### BRIEF DESCRIPTION OF THE DRAWINGS

FIG. 1 is a block diagram depicting an exemplary cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is an additional block diagram depicting an exemplary functional relationship between various aspects of the present invention;

FIG. 5 is block flow diagram depicting an exemplary system and functionality for accelerating machine learning in a computing environment by a processor in which aspects of the present invention may be realized;

FIG. 6 is a flowchart diagram depicting an exemplary method for accelerating machine learning in a computing environment by a processor in which aspects of the present invention may be realized;

FIG. 7 is a flowchart diagram depicting an exemplary method for accelerating machine learning in a computing environment by a processor in which aspects of the present invention may be realized; and

FIG. 8 is a flowchart diagram depicting an exemplary method for accelerating machine learning in a computing environment in a computing environment by a processor in a computing environment by a processor, again, in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular datasets and use the generalizations to solve associated problems by, for example, classifying new data. Once a machine learns generalizations from (or is trained using) known properties from the input or training data, it can apply the generalizations to future data to predict unknown properties.

Moreover, machine learning is a form of AI that enables a system to learn from data rather than through explicit programming. A major focus of machine learning research is to automatically learn to recognize complex patterns and make intelligent decisions based on data, and more efficiently train machine learning models and pipelines. However, machine learning is not a simple process. As the algorithms ingest training data, it is then possible to produce more precise models based on that data. A machine-learning model is the output generated when a machine-learning algorithm is trained with data. After training, input is provided to the machine learning model which then generates an output. For example, a predictive algorithm may create a predictive model. Then, the predictive model is provided with data and a prediction is then generated (e.g., “output”) based on the data that trained the model.

Machine learning enables machine learning models to train on datasets before being deployed. Some machine-learning models are online and continuous. This iterative process of online models leads to an improvement in the types of associations made between data elements. Different conventional techniques exist to create machine-learning (ML) models and neural network (NN) models. The basic prerequisites across existing approaches include having a dataset, as well as basic knowledge of ML model synthesis, NN architecture synthesis and coding skills.

In one aspect, automated AI machine learning systems (“AutoAI systems” or automated machine learning systems “auto ML system”) may generate multiple (e.g., hundreds) of machine learning pipelines. Designing a machine learning pipeline involves several decisions such as, for example, which data preparation and preprocessing operations should be applied, which machine algorithm should be used with which settings (hyperparameters). AutoML systems may automatically search for an approved or satisfactorily performing pipeline. For this purpose, several machine learning pipelines may be selected and trained to convergence. Its performance is estimated on a hold-out set of the data.

However, training a machine learning model on the entire dataset and waiting until convergence is time consuming. Furthermore, the advantage of the invention is it is more efficient and can leverage the beginning process to identify an optimal or best machine learning pipeline.

Accordingly, various embodiments of the present invention improve the efficiency of existing automated machine learning systems by accelerating the machine learning process. In one aspect, as described herein, various embodiments provide for accelerating machine learning in automated machine learning systems. In one aspect, selected data may be received for training machine learning pipelines. Each of the machine learning pipelines may be scored according to one or more learning curves while training on selected data. Completion of the training on the selected data may be permitted for those of the machine learning pipelines having a score greater than a selected threshold. The training on the selected data may be terminated, prior to completion, on those of the machine learning pipelines having a score less than a selected threshold. Thus, the present invention may leverage the beginning process of training machine learning pipeline, as compared to waiting until completion of the training process on the machine learning model, to identify an optimal or best machine learning pipeline.

Said differently, the machine learning system may continue improving the learning process by leveraging knowledge gathered from previous experiments (e.g., such as, for example, experiments with selected data on various machine learning pipelines). Each machine learning training operation may be monitored and those of the machine learning pipelines that lack a predicted machine learning potential may be terminated based on the learning curve and the machine learning pipeline configuration. Alternatively, those of the machine learning pipelines that predicted to have machine learning potential may be allowed to continue training.

Each trained machine learning pipelines may be ranked at the time of training completion according to the scoring the machine learning pipeline while training on the dataset based on at least a partial learning curve and/or other learning curves (e.g., historical learning curves). A trained machine learning pipeline (trained on the dataset) may be identified and selected as the “optimal” or “best” machine learning pipeline (e.g., an optimized machine learning pipeline) according to the ranking of the trained machine learning pipelines that are each permitted to complete training on the dataset in response to applying, during the training, one or more learning curves (which may include one or more partial learning curves) that predicts a machine learning pipeline performance level.

In an additional aspect, as used herein, there may be two types of learning curves. In one aspect, (e.g., definition 1), a learning curve may be a function that maps a number of training iterations spent to a validation loss. In an alternative aspect, (e.g., definition 2), a learning curve may be a function that maps the fraction of data used from the entire training data to the validation loss. The learning curves may become longer the more training time is spent for the machine learning model. Thus, the mechanisms of the illustrated embodiments, such as, for example, an automated machine learning system, is enabled to process and handle each learning curve that have an arbitrary length and both definition types (e.g., the various learning curve may can even be combined).

In one aspect, a validation loss may be a metric that defines how well (e.g., a measurable value, ranking, range of values, and/or a percentage indicating a performance level) a machine learning model performs. The validation loss may be the loss computed on data that has not been used to train the machine learning model and gives an idea how well the model will perform when being used in practice on new data.

In another aspect, mechanisms of the illustrated embodiments may automatically and efficiently design machine learning pipelines by taking as input, a dataset, and returning as output, a trained machine learning pipeline. An automated machine learning system may be used to search and train machine learning pipelines. A job terminator may be used to monitor training jobs and terminate unpromising ones early (e.g., prior to completion of training of a machine learning model). A learning curve ranker may be used to learn from historic learning curves how well a training job will perform based on a partially observed learning curve (e.g., a complete or partial learning curve observed for a machine learning model currently being trained).

Accordingly, as depicted herein, the present invention provides accelerating the machine learning process and enables any type of automated machine learning system to explore several machine learning models prior to identifying, selecting, and choosing the best/optimal machine learning model. Each time the training of each of the machine learning models occurs, the automated machine learning system may determine how well the particular machine learning model performs prior to completion of the training thereby increasing the computationally efficiency. The mechanisms of the illustrated embodiments eliminate the need to train each machine learning model to completion by terminating the training of poorly performing machine learning models (e.g., predicted performance based on a learning curve is less than a selected threshold) early on (e.g., prior to the completion of the training on a dataset). The mechanisms of the illustrated embodiments may be compatible with any type of automated machine learning system and may be used for neural architecture search as well as hyperparameter optimization.

In one aspect, as used herein, a machine learning pipeline may be one or more processes, operations, or steps to train a machine learning process or model (e.g., creating computing application code, performing various data operations, creating one or more machine learning models, adjusting and/or tuning a machine learning model or operation, and/or various defined continuous operations involving machine learning operations). In addition, a machine learning pipeline may be one or more machine learning workflows that may enable a sequence of data to be transformed and correlated together in a machine learning model that may be tested and evaluated to achieve an outcome. Additionally, a trained machine learning pipeline may include an arbitrary combination of different data curation and preprocessing steps. The machine learning pipeline may include at least one machine learning model. Also, a trained machine learning pipeline may include at least one trained machine learning model.

In one aspect, a “machine learning model” may be a system that takes as input the curated and preprocessed data and will output a prediction (e.g., the output of all steps that happened before in the machine learning pipeline), depending on the task, and the prediction may be a forecast, a class, and/or a more complex output such as, for example, sentences in case of translation. In another aspect, a machine-learning model is the output generated upon training a machine-learning algorithm with data. After training, the machine learning model may be provided with an input and the machine learning model will provide an output.

Also, a machine learning model may be a system that that has been trained to recognize certain types of patterns. In an additional example, a machine learning operation/algorithm may be the procedures that are implemented in computer code and are run on data. Machine learning models are output by the machine learning operations/algorithms and are comprised of model data and a prediction algorithm. The machine learning operation/algorithm may provide a type of automatic programming where machine learning models represent the program.

It should be noted that one or more calculations may be performed in machine learning and may use various mathematical operations or functions that may involve one or more mathematical operations (e.g., performing rates of change/calculus operations, solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, “optimize” need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

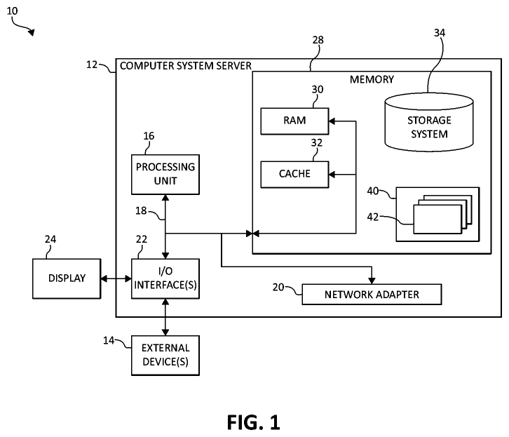

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

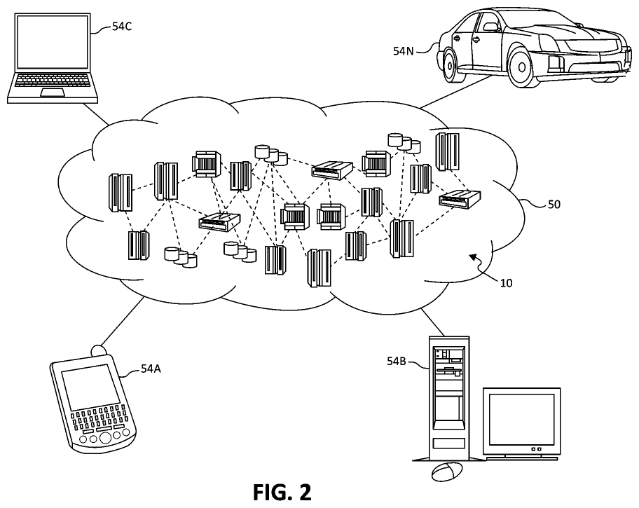

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

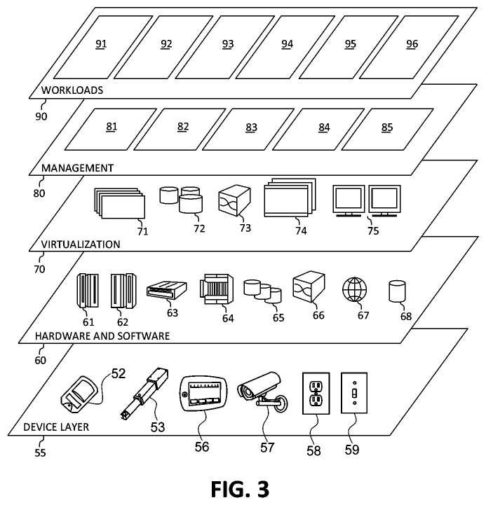

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for accelerating machine learning in a computing environment (e.g., in a neural network architecture). In addition, workloads and functions 96 for accelerating machine learning in a computing environment may include such operations as analytics, deep learning, and as will be further described, user and device management functions. One of ordinary skill in the art will appreciate that the workloads and functions 96 for accelerating machine learning in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for providing automating decision making for a neural architecture search in a computing environment in a computing system. One or more hardened machine learning models that are secured against adversarial challenges are provided by applying one or more of a plurality of combinations of selected preprocessing operations from one or more machine learning models, a dataset used for hardening the one or more machine learning models, a list of preprocessors, and a selected number of learners.

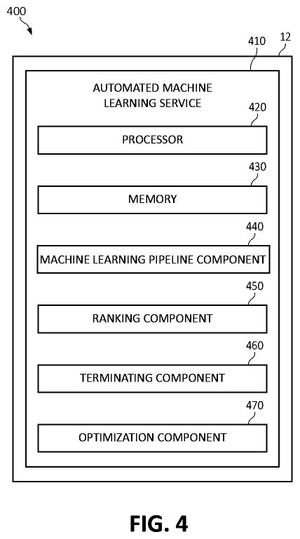

Turning now to FIG. 4, a block diagram depicting exemplary functional components of system 400 for accelerating machine learning in a computing environment (e.g., in a neural network architecture) according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

A automated machine learning service 410 is shown, incorporating processing unit 420 (“processor”) to perform various computational, data processing and other functionality in accordance with various aspects of the present invention. In one aspect, the processor 420 and memory 430 may be internal and/or external to the automated machine learning service 410, and internal and/or external to the computing system/server 12. The automated machine learning service 410 may be included and/or external to the computer system/server 12, as described in FIG. 1. The processing unit 420 may be in communication with the memory 430. The automated machine learning service 410 may include a machine learning pipeline component 440, a ranking component 450, a terminating component 460, and a optimization component.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

In one aspect, the machine learning pipeline component 440 may receive a dataset for training a machine learning pipeline. That is, selected data may be selected and/or received for training machine learning pipelines. A machine learning pipeline may include one or more machine learning models, a plurality of various data curations, one or more processing operation, or a combination thereof.

The machine learning pipeline component 440 may learn, generate and store one or more learning curves (e.g., a partial or complete learning curve) for each machine learning pipeline while training on the dataset. The learning curves (which may include historical learning curves and currently learned learning curves relating to the current machine learning pipeline) may be used, compared, applied, used and/or selected from a historical database or from machine learning on the data set being trained so as to predict a machine learning pipeline performance level for each machine learning pipeline being trained on the dataset.

The machine learning pipeline component 440, in association with the ranking component 450, may score each machine learning pipelines, while training on the dataset, according to the learning curves. In one aspect, the learning curve may be a partial learning curve.

The machine learning pipeline component 440, in association with the terminating component 460, may permit the training of those of the machine learning pipelines having a score, assigned in response to applying the one or more learning curves, greater than the defined threshold.

Alternatively, the machine learning pipeline component 440, in association with the terminating component 460, may terminate the training of those of the machine learning pipelines having a score, assigned in response to applying the one or more learning curves, less than the defined threshold. It should be noted that a threshold may be a value, a percentage, and/or a value within a defined range such as, for example, a range of 0 to 1.

The machine learning pipeline component 440, in association with the ranking component 450, may rank each machine learning pipelines according to the assigned score in response to completion of the training of the machine learning pipeline.

The machine learning pipeline component 440, in association with the optimization component 470, may identify and/or select a machine learning pipeline (e.g., an optimized or best machine learning pipeline) that has been trained on a dataset according to the ranking of a plurality of machine learning pipelines based on the application, during the training, one or more learning curves that predicts a machine learning pipeline performance level

In one aspect, the automated machine learning service 410 (e.g., one or more components of the automated machine learning service 410 such as, for example, the machine learning component 440, the ranking component 450, the terminating component 460, and/or the optimization component 470), as described herein, may be performed by various machine learning operations for automated evaluation of machine learning models such as, for example for automatically evaluating and determining a level of robustness of a machine learning model against adversarial whitebox attacks, and analyzing results from the adversarial attack and generating a modified machine learning model in response to the evaluating and determining by using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

In one aspect, the automated machine learning service 410 may perform one or more operations using various operations or functions that may involve one or more determination operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

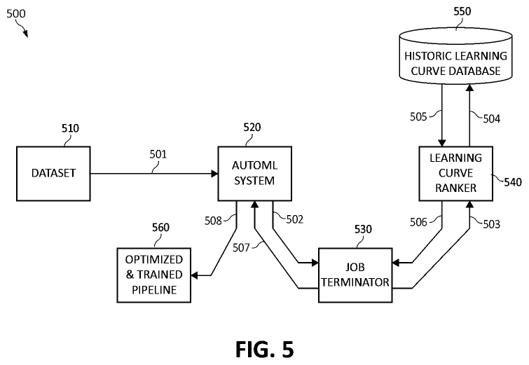

Turning now to FIG. 5, a block diagram depicts exemplary an system 500 and functionality for automating decision making for a neural architecture search in a computing environment. In one aspect, one or more of the components, modules, services, applications, and/or functions described in FIGS. 1-4 may be used in FIG. 5.

As shown, various blocks of functionality are depicted with arrows designating the blocks' of system 500 relationships with each other and to show process flow (e.g., steps or operations). Additionally, descriptive information is also seen relating each of the functional blocks' of system 500. As will be seen, many of the functional blocks may also be considered “modules” of functionality, in the same descriptive sense as has been previously described in FIGS. 1-4. With the foregoing in mind, the module blocks' of system 500 may also be incorporated into various hardware and software components of a system for accelerated machine learning in a computing environment in accordance with the present invention. Many of the functional blocks 500 may execute as background processes on various components, either in distributed computing components, or elsewhere.

As depicted, system 500 includes an automated machine learning system 520 (“autoML system”), a job terminator 530, a learning curve ranker 540, historic learning curve database 550, and an optimized and trained machine learning pipeline 560.

As depicted in FIG. 5, starting in step 501 (the dataset 510), a user may input selected data such as, for example, a dataset, a task, and various constraints, into the automated machine learning system 520 (e.g., “AutoML System).

In step 502, the automated machine learning system 520 may begin the process for searching and identifying an optimal/optimized machine learning pipeline. In one aspect, the automated machine learning system 520 may consume a dataset and will output a trained machine learning pipeline. It should be noted that a trained machine learning pipeline may include an arbitrary combination of different data curation and preprocessing steps. The trained machine learning pipeline (e.g., the optimized and trained machine learning pipeline 560) may include at least one trained machine learning model. While the machine learning training is performed, the automated machine learning system 520 may generate learning curves (which may include only a partial learning curve).

It should be noted that for every new machine learning pipeline and every further observation of the learning curve, the job terminator 530 may be queried.

In step 503, the job terminator 530 may query (e.g., ask) the learning curve ranker 540 to provide a score for a given machine learning pipeline configuration (e.g., the current machine learning pipeline being trained on the dataset 510) and learning curve.

In step 504, learning curve ranker 540 may update the historic learning curve database 550 (with one or more learned partial or complete learning curves for each machine learning pipeline being trained on the dataset 510). The historic learning curve database 550 may include all machine learning pipeline configurations and all learning curves ever encountered and/or processed by the automated machine learning system 520. Thus, the historic learning curve database 550 is an ever-growing database.

Thus, the learning curve ranker 540 may include the history of each previous learning curve stored in the historic learning curve database 550 and each corresponding machine pipeline configurations (e.g., a first input “input 1” or first machine learning pipeline configuration—that is, the “input” is the configuration or description of the machine learning pipelines). Also, the learning curve ranker 540 may include learning curves and configurations of machine learning pipelines generated from the automated machine learning system 520 (e.g., a second input “input 2” or second machine learning pipeline configuration/description). Additionally, the automated machine learning system 520 may include machine learning pipeline configurations and partial learning curves of pipelines under consideration (e.g., a third input “input 3” or third machine learning pipeline configuration/description), and configuration and learning curve of the best pipeline found so far (e.g., a fourth input “input 4” or fourth machine learning pipeline configuration/description).

The learning curve ranker 540 may use a machine learning model to estimate the probability for each of the machine learning pipelines such as, for example, a third machine learning pipeline configuration may improve over a best machine pipeline such as, for example, a fourth machine learning pipeline configuration. In order to achieve this, the machine learning model may be trained on input 1 and 2 (e.g., the first machine learning pipeline and the second machine learning pipeline configuration/description). Any machine learning model may be considered for a selected task/job. The output of the learning curve ranker 540 may be an estimation of the probability that a given machine learning pipeline (e.g., Input 3 or third machine learning pipeline configuration/description) will improve over the current best ML pipeline (Input 4 or fourth machine learning pipeline configuration/description).

In step 505, the learning curve ranker 540 may query the historic learning curve database 550 for any relevant metadata and then updates a machine learning model with the retrieved, relevant metadata.

In step 506, a scores may be returned by the learning curve ranker 540 to the job terminator 530 for the given learning curve(s) and machine learning pipelines configurations.

In step 507, based on these scores, the job terminator 530 may informs the automated machine learning system 520 as to whether the automated machine learning system 520 should continue or terminate a training job for the current machine learning pipeline.

In one aspect, the job terminator 530 may take the output of the learning curve ranker 540 to decide whether to terminate a machine learning pipeline training job. For example, the decision may determine to terminate all machine learning pipelines having a probability of improving over a currently identified best/optimized machine learning pipeline (e.g., a first trained machine learning pipeline used as baseline for comparison with a selected threshold) below a given threshold. That is, a threshold may be used to determine whether or not one or more machine learning pipelines are to be terminated.

Thus, depending on the automated machine learning system 520, the job terminator 530 may return an estimation of the loss (e.g., squared error (regression problems), cross-entropy loss (e.g., classification problems)), achieved by the current machine learning pipeline that is being trained. This estimation may be, for example, returning a smallest loss observed on a learning curve or by predicting a loss using a partial learning curve for the machine learning pipeline. Also, in one aspect, the job terminator 530 may be in communication and/or coupled to the learning curve ranker 540 into a single component (e.g., the job terminator 530 and the learning curve ranker 540 may be a single component)

In block 508, the automated machine learning system 520 may identify, select, and/or return the optimized and trained machine learning pipeline (e.g., the best/optimal identified machine learning pipeline).

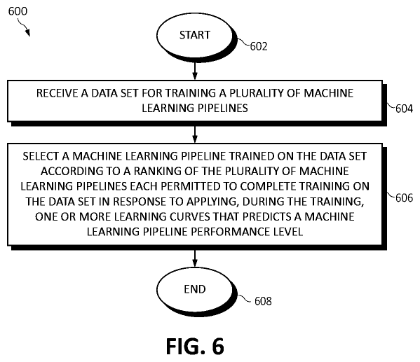

Turning now to FIG. 6, a method 600 for accelerating machine learning in a computing environment using a processor is depicted, in which various aspects of the illustrated embodiments may be implemented. The functionality 600 may be implemented as a method (e.g., a computer-implemented method) executed as instructions on a machine, where the instructions are included on at least one computer readable medium or one non-transitory machine-readable storage medium. The functionality 600 may start in block 602.

A dataset may be received for training a plurality of machine learning pipelines, as in block 604. A machine learning pipeline, trained on the dataset, may be selected according to a ranking of the plurality of machine learning pipelines each permitted to complete training on the dataset in response to applying, during the training, one or more learning curves that predicts a machine learning pipeline performance level, as in block 606. The functionality 600 may end, as in block 608.

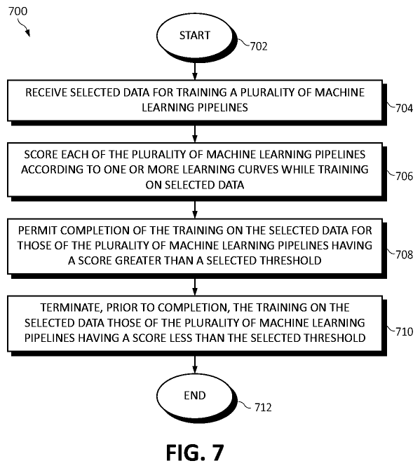

Turning now to FIG. 7, an additional method 700 for accelerating machine learning in a computing environment using a processor is depicted. The functionality 700 may be implemented as a method (e.g., a computer-implemented method) executed as instructions on a machine, where the instructions are included on at least one computer readable medium or one non-transitory machine-readable storage medium. The functionality 700 may start in block 702.

Selected data may be received for training a plurality of machine learning pipelines, as in block 704. Each of the plurality of machine learning pipelines may be scored according to one or more learning curves while training on selected data, as in block 706. Completion of the training on the selected data may be permitted for those of the plurality of machine learning pipelines having a score greater than a threshold (e.g., a selected threshold), as in block 708. The training on the selected data may be terminated, prior to completion, on those of the plurality of machine learning pipelines having a score less than a selected threshold, as in block 710. The functionality 700 may end, as in block 712.

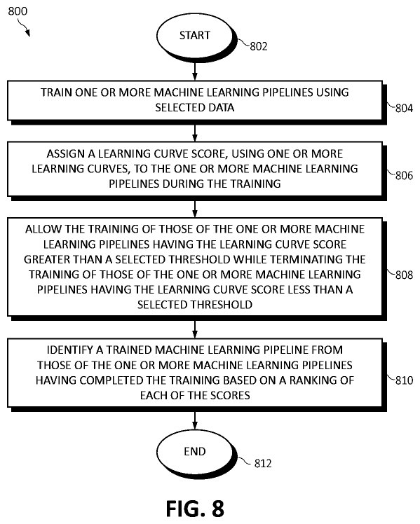

Turning now to FIG. 8, an additional method 800 for accelerating machine learning in a computing environment using a processor is depicted. The functionality 800 may be implemented as a method (e.g., a computer-implemented method) executed as instructions on a machine, where the instructions are included on at least one computer readable medium or one non-transitory machine-readable storage medium. The functionality 800 may start in block 802.

One or more machine learning pipelines may be trained using selected data, as in block 804. A learning curve score may be assigned, using one or more learning curves, to the one or more machine learning pipelines during the training, as in block 806.

The training of those of the one or more machine learning pipelines having the learning curve score greater than a selected threshold may be allowed (e.g., permitted/authorized) while the training of those of the one or more machine learning pipelines having the learning curve score less than a selected threshold may be terminated, as in block 808. The learning curve score may also be used to rank each one or more machine learning pipeline that completed training in relation to previously trained machine learning pipelines on the same selected data.

A trained machine learning pipeline may be identified (and selected) from those of the one or more machine learning pipelines having completed the training based on a ranking of each of the scores, as in block 810. The functionality 800 may end, as in block 812.

In one aspect, in conjunction with and/or as part of at least one blocks of FIGS. 6-8, the operations of 600, 700, and/or 800 may include each of the following. The operations of 600, 700, and/or 800 may generate and store the one or more learning curves for each of the plurality of machine learning pipelines while training on the dataset and learn from the one or more learning curves to apply and predict a machine learning pipeline performance level on each training operation for a subsequent machine learning pipeline on the dataset.

The operations of 600, 700, and/or 800 may score each of the plurality of machine learning pipelines according to the one or more learning curves while training on the dataset.

The operations of 600, 700, and/or 800 may permit (e.g., authorize and permit) the training of those of the plurality of machine learning pipelines having a score, assigned in response to applying the one or more learning curves, greater than the defined threshold. The operations of 600, 700, and/or 800 may terminate the training of those of the plurality of machine learning pipelines having a score, assigned in response to applying the one or more learning curves, less than the defined threshold.

The operations of 600, 700, and/or 800 may rank each of the plurality of machine learning pipelines according to scoring each of the plurality of machine learning pipelines according to the one or more learning curves while training on the dataset.

The operations of 600, 700, and/or 800 may receive the dataset for training a machine learning pipeline. In one aspect, a machine learning pipeline includes one or more machine learning models, a plurality of various data curations, one or more processing operation, or a combination thereof.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automated evaluation of machine learning models in a computing environment by one or more processors comprising:
automatically evaluating and determining a level of robustness of a machine learning model against adversarial whitebox attacks; and
analyzing results from the adversarial attack and generating a modified machine learning model in response to the evaluating and determining.

2. The method of claim 1, further including receiving the machine learning model, a data set used for testing the machine learning model, one or more adversarial attack objectives, an attack threat model, and a selected number of hyperparameters.

3. The method of claim 1, further including generating an evaluation summary based on evaluating and determining of the level of robustness of the machine learning model.

4. The method of claim 1, further including automatically commencing the evaluating and determining the level of robustness of the machine learning model against the adversarial whitebox attacks using partial inputs from a previous evaluation of the machine learning model.

5. The method of claim 1, further including:
adjusting one or more adversarial attack objectives, an attack threat model, a selected number of hyperparameters, and a data set used for testing the machine learning model; and
reconfiguring or adjusting an unmasking of gradients of the machine learning model, a loss function, an adversarial attack, and reanalyzing the results from the adversarial attacks based.

6. The method of claim 1, further including:
determining a robustness score for the machine learning model indicating a level of security from against adversarial whitebox attacks; and
ranking the machine learning model based on the robustness score.

7. The method of claim 1, further including initializing a machine learning operation to:
learn and store the level of robustness of the machine learning model against the adversarial whitebox attacks based on the machine learning model, a data set used for testing the machine learning model, one or more adversarial attack objectives, an attack threat model, and a selected number of hyperparameters; and
collect feedback in relation to automatically performing the diagnosis and evaluation of the level of robustness of a machine learning model against adversarial whitebox attacks to generate the modified machine learning model in response to performing at least a portion of the diagnosis and evaluation operation.

8. A system for automated evaluation of machine learning models in a computing environment, comprising:
one or more computers with executable instructions that when executed cause the system to:
automatically evaluate and determine a level of robustness of a machine learning model against adversarial whitebox attacks; and
analyzing results from the adversarial attack and generating a modified machine learning model in response to the evaluating and determining.

9. The system of claim 8, wherein the executable instructions when executed cause the system to receive the machine learning model, a data set used for testing the machine learning model, one or more adversarial attack objectives, an attack threat model, and a selected number of hyperparameters.

10. The system of claim 8, wherein the executable instructions when executed cause the system to generate an evaluation summary based on evaluating and determining of the level of robustness of the machine learning model.

11. The system of claim 8, wherein the executable instructions when executed cause the system to automatically commence evaluating and determining the level of robustness of the machine learning model against the adversarial whitebox attacks using partial inputs from a previous evaluation of the machine learning model.

12. The system of claim 8, wherein the executable instructions when executed cause the system to:
adjust one or more adversarial attack objectives, an attack threat model, a selected number of hyperparameters, and a data set used for testing the machine learning model; and
reconfigure or adjust an unmasking of gradients of the machine learning model, a loss function, an adversarial attack, and reanalyzing the results from the adversarial attacks based.

13. The system of claim 8, wherein the executable instructions when executed cause the system to:
determine a robustness score for the machine learning model indicating a level of security from against adversarial whitebox attacks; and
rank the machine learning model based on the robustness score.

14. The system of claim 8, wherein the executable instructions when executed cause the system to initialize a machine learning operation to:
learn and store the level of robustness of the machine learning model against the adversarial whitebox attacks based on the machine learning model, a data set used for testing the machine learning model, one or more adversarial attack objectives, an attack threat model, and a selected number of hyperparameters; and
collect feedback in relation to automatically performing the diagnosis and evaluation of the level of robustness of a machine learning model against adversarial whitebox attacks to generate the modified machine learning model in response to performing at least a portion of the diagnosis and evaluation operation.

15. A computer program product for automated evaluation of machine learning models in a computing environment, the computer program product comprising:
one or more computer readable storage media, and program instructions collectively stored on the one or more computer readable storage media, the program instruction comprising:
program instructions to automatically evaluate and determine a level of robustness of a machine learning model against adversarial whitebox attacks; and
analyze results from the adversarial attack and generate a modified machine learning model in response to the evaluating and determining.

16. The computer program product of claim 15, further including program instructions to receive the machine learning model, a data set used for testing the machine learning model, one or more adversarial attack objectives, an attack threat model, and a selected number of hyperparameters.

17. The computer program product of claim 15, further including program instructions to generate an evaluation summary based on evaluating and determining of the level of robustness of the machine learning model.

18. The computer program product of claim 15, further including program instructions to automatically commence evaluating and determining the level of robustness of the machine learning model against the adversarial whitebox attacks using partial inputs from a previous evaluation of the machine learning model.

19. The computer program product of claim 15, further including program instructions to:
adjust one or more adversarial attack objectives, an attack threat model, a selected number of hyperparameters, and a data set used for testing the machine learning model; and
reconfigure or adjust an unmasking of gradients of the machine learning model, a loss function, an adversarial attack, and reanalyzing the results from the adversarial attacks based.

20. The computer program product of claim 15, further including program instructions to:
determine a robustness score for the machine learning model indicating a level of security from against adversarial whitebox attacks; and
rank the machine learning model based on the robustness score.

21. The computer program product of claim 15, further including program instructions to initialize a machine learning operation to:
learn and store the level of robustness of the machine learning model against the adversarial whitebox attacks based on the machine learning model, a data set used for testing the machine learning model, one or more adversarial attack objectives, an attack threat model, and a selected number of hyperparameters; and
collect feedback in relation to automatically performing the diagnosis and evaluation of the level of robustness of a machine learning model against adversarial whitebox attacks to generate the modified machine learning model in response to performing at least a portion of the diagnosis and evaluation operation.

22. A method for automated evaluation of machine learning models using machine learning operations in a computing environment by one or more processors comprising:
receiving a machine learning model, a data set used for testing the machine learning model, one or more adversarial attack objectives, an attack threat model, and a selected number of hyperparameters;
automatically evaluating and determining a level of robustness of the machine learning model against an adversarial whitebox attack and analyzing results from the adversarial attack; and
generating a modified machine learning model in response to the evaluating and determining.

23. The method of claim 21, further including generating an evaluation summary based on evaluating and determining of the level of robustness of the machine learning model.

24. The method of claim 21, further including:
adjusting the one or more adversarial attack objectives, the attack threat model, the selected number of hyperparameters, and the data set used for testing the machine learning model; and
reconfiguring or adjusting an unmasking of gradients of the machine learning model, a loss function, an adversarial attack, and reanalyzing the results from the adversarial attacks.

25. A method for accelerating machine learning in a computing environment by one or more processors comprising:
automatically evaluating and determining a level of robustness of the machine learning model against an adversarial whitebox attack by applying a data set used for testing the machine learning model, one or more adversarial attack objectives, an attack threat model, and a selected number of hyperparameters;
generating an evaluation summary based on evaluating and determining of the level of robustness of the machine learning model.
